(19) United States
(12) Patent Application Publication
(10) Pub. No.: US 2026/0296124 A1
(43) Pub. Date: Oct. 1, 2026

(54) SEAT-POINT ADJUSTMENT DEVICE

(71) Applicant: Vibracoustic SE, Weinheim (DE)

(72) Inventors: Ersan Altinoluk, Hamburg (DE); Dieter Bulling, Wedemark (DE)

(21) Appl. No.: 19/483,339

(22) PCT Filed: Apr. 30, 2024
(86) PCT No.: PCT/EP2024/061887

§ 371 Date: Nov. 11, 2025

(30) Foreign Application Priority Data
May 11, 2023 (DE) 10 2023 112 509.5

(51) Int. Cl. B60G 17/052; B60G 17/027; F16F 9/05

(52) U.S. Cl. CPC B60G 17/052; B60G 17/0272; F16F 9/05

(57) ABSTRACT

A seat-point adjustment device through which a central longitudinal axis extends includes a first part and a second part, each having a passage in the direction of the central longitudinal axis; a radially outer rolling bellows which extends, radially outside with respect to a liquid volume, from the first part to the second part; and a radially inner rolling bellows which extends, radially inside with respect to the liquid volume, from the first part to the second part, wherein the radially inner rolling bellows forms a radially inner seal of the liquid volume.

### CROSS-REFERENCE TO RELATED APPLICATIONS

This application claims priority to International Patent Application No. PCT/EP 2024/061887, filed on Apr. 30, 2024, and German Patent Application No. DE 10 2023 112 509.5, filed on May 11, 2023, the contents of both of which are hereby incorporated by reference in their entirety.

### TECHNICAL FIELD

The invention relates to a seat-point adjustment device.

### BACKGROUND

Seat-point adjustment devices which have a central passage are known in practice. These seat-point adjustment devices can be adjusted mechanically, hydraulically or pneumatically. In the case of hydraulic or pneumatic seat-point adjustment devices having a central passage and a hydraulically or pneumatically filled actuator pressure chamber, one of the challenges is the radially inner sealing of the pressurized actuator pressure chamber with respect to the central passage in order to avoid pressure losses.

For this purpose, a folding bellows of a pneumatically operated seat-point adjustment device which is arranged radially inside with respect to the actuator pressure chamber is known in practice. The folding bellows cannot lie on a contour, due to its geometry, and must remain dimensionally stable even under pressure. If its folds deform under excessive pressure, the folding bellows cannot fold up as defined. Therefore, this solution can be used only for low air pressures.

As an alternative to the folding bellows, sliding seals or o-rings are also known in practice for radially inner sealing, in particular in hydraulic actuator concepts. These seals are usually also used due to limitations on installation space. However, sliding seals are complex, expensive to manufacture, and susceptible to wear and do not have satisfactory sealing over the service life. The friction occurring in the seal also increases the power required for adjustment and the wear.

In vehicles, the vehicle body is connected to the hub carrier by means of struts, which are part of the suspension. These struts or spring-damper units allow the body to be vertically decoupled from the hub carrier movements. The struts can contain steel suspension springs, for example coil springs. Known struts with steel springs can comprise a seat-point adjustment device. The steel suspension springs are statically loaded and statically pre-compressed with different intensity according to the loading situation of the vehicle. This changes the distance between the wheels or the hub carriers and the vehicle body. Various mobility concepts require that the vehicle level can be kept constant or set in a controlled manner even in different loading states. For example, for the cooling of batteries in the underbody of electrically operated vehicles, optimized positioning with respect to the apparent wind is required or optimal ground clearance is required. Large unevenness of the roadway, too, can make an increase in ground clearance appear advantageous. Therefore, the level control desired for this purpose is accomplished by adjusting the vertical position of the upper (seat-point adjustment device placed above the suspension spring) and/or lower (seat-point adjustment device placed below the suspension spring) seat point of the suspension springs. The adjustment of the vertical position can be achieved mechanically, for example when a disc, on which the spring rests and which thus defines the seat point of the helical spring, can be moved vertically by means of a screw thread. However, solutions in which the seat-point adjustment device can be adjusted by means of hydraulics are also known.

Various technical solutions of seat-point adjustment devices require a central passage. The central passage may be necessary, for example, in order to lead a tubular damper through the seat-point adjustment device from the hub carrier to the body-side mounting point of the damper. However, a central passage can also be advantageous, for example, for providing within the seat-point adjustment device a guide element which allows vertical movements of the seat-point adjustment device but can receive radial forces. In the case of hydraulically adjustable seat-point adjustment devices, the adjustable helical-spring receptacles are adjusted by means of a hydraulic pressure build-up in the pressure chamber below the helical-spring receptacle. If such seat-point adjustment devices then have a central passage, this central passage extends through the pressure chamber in most of the technical solutions. In this case, the pressure chamber must be sealed at the usually tubular central passage, for which purpose sealing rings are regularly used, which must also enable a vertical sliding function in addition to the sealing function. This leads essentially to two disadvantages. First, it is common to use seals that slide on the radially inner side; such seals can be damaged by dirt or tribological wear and they develop leaks. Second, such sealing elements usually have a relatively small effective surface which must withstand a high pressure. All components must therefore be designed accordingly.

### SUMMARY

An object of the invention is to improve the prior art accordingly, in particular with regard to improved sealing of a liquid volume in a pressure chamber of a seat-point adjustment device.

Aspects and features of the invention are disclosed herein.

According to embodiments of the invention, a seat-point adjustment device through which a central longitudinal axis extends is proposed, comprising a first part and a second part each having a passage in the direction of the central longitudinal axis; a radially outer rolling bellows which extends, radially outside with respect to a liquid volume, from the first part to the second part; and a radially inner rolling bellows which extends, radially inside with respect to the liquid volume, from the first part to the second part, wherein the radially inner rolling bellows forms the radially inner seal of the liquid volume.

It has been recognized that the liquid volume of a seat-point adjustment device can be sufficiently sealed radially inwards by using a radially inner rolling bellows. Therefore, a conventional seal hitherto arranged there, such as a sliding seal or o-rings, can be dispensed with. The radially inner rolling bellows and/or the radially outer rolling bellows can also be referred to as a diaphragm. Such a diaphragm may comprise, for example, an elastomer matrix, which may be reinforced with a textile reinforcement, for example thread layers which cross one another.

Another advantage is the ability to tolerate dirt. Since it is not necessary to seal with sliding on a surface, the radially inner rolling bellows can also roll on dirt or damage to the surfaces without the sealing tightness being affected.

The radially inner rolling bellows also solves the wear problem due to its rolling properties. Since the radially inner rolling bellows lies on adjacent surfaces instead of causing friction with them, the seat-point adjustment device is considerably improved in terms of material loading and wear.

The radially inner rolling bellows also improves the pressure state. Because the installation space around the liquid volume is used, the liquid pressure can be distributed over a large effective surface of the radially inner rolling bellows and thus kept low, for example in comparison to o-rings, in the case of which the liquid pressure acts on a very small surface.

The first part can be a volume cover. The first part can delimit the liquid volume axially in a first axial direction. The second part can be a volume cover. The second part can delimit the liquid volume axially in a second axial direction. The first and second axial directions can extend opposite one another, proceeding from the liquid volume. The liquid volume can be delimited in the first axial direction by the first part, in the second axial direction by the second part, radially outwards by the radially outer rolling bellows, and radially inwards by the radially inner rolling bellows, preferably exclusively. The liquid volume can be toroidal. The liquid volume can be or is filled with a liquid. The liquid can be an incompressible liquid. The liquid, in particular the incompressible liquid, is used to prevent resilience of the seat-point adjustment device. The seat-point adjustment device is suitable for the static adjustment of a seat point of a spring, for example a coil spring.

It is conceivable that one of the two parts has a spring receptacle suitable for receiving a spring of a spring unit. It is conceivable that the other of the two parts can be connected to a vehicle, for example at the body or at the hub carrier. It is conceivable that one of the two parts has a valve for the liquid volume for introducing a liquid into or releasing it from the liquid volume.

The two parts are arranged and/or configured so as to be movable relative to one another at least along the central longitudinal axis. One of the two parts can be movable relative to the other of the two parts and can be guided by means of a guide. They can be movable between a proximity position and a distance position. The two parts can be arranged at a distance from one another along the central longitudinal axis. The two parts can be arranged opposite one another along the central longitudinal axis, i.e. on two opposite sides of the liquid volume. The distance between the two parts can be set by means of the filling state of the liquid volume—a volume increase causes a distance increase, while a volume decrease causes a distance decrease. The liquid which is or can be present in the liquid volume has the effect that a volume change is not caused by external forces that occur in the case of vehicles.

The two rolling bellows can each be fastened to the first part and to the second part, such that a fastening point is formed. The first rolling bellows can be fastened to the two parts separately from the second rolling bellows, and vice versa.

The seat point is the support point of a spring, in particular a coil spring, on the hub carrier side or on the body side. A seat-point adjustment device is used to set a distance between the hub carrier and the support point of the spring on the hub carrier side and/or between the body and the support point of the spring on the body side, independently of the spring travel. The distance between the body and the hub carrier can be adjusted by adjustment of the seat-point adjustment device. While a spring is subjected to dynamic deflections during driving, the adjustment travel of the seat-point adjustment device can remain nearly constant during driving. Its adjustment travel cannot be adjusted by external stimuli from the roadway, but rather can be set in a controlled way and can then remain in this position.

The direction indications “radial”, “radial direction”, “axial” and “axial direction” relate to the central longitudinal axis.

According to a conceivable development of the seat-point adjustment device, it can be provided that, apart from the radially inner rolling bellows, the seat-point adjustment device has no further sealing devices between the two parts movable relative to one another, for sealing the liquid volume
radially inwards and/or
with respect to an inner circumference of the moving part among the two parts and/or
with respect to an inner circumference of that piece of the multi-piece part on which the radially inner rolling bellows is arranged.

The radially inner rolling bellows can therefore form the only radially inner seal of the liquid volume.

According to a development of the seat-point adjustment device, it can comprise an inner wall, which can be arranged radially inside with respect to the radially inner rolling bellows, and the radially inner rolling bellows can be configured and/or arranged to unroll on and/or lie on the inner wall. The inner wall can be a cylindrical portion extending along the central longitudinal axis. The inner wall can have an outer circumferential surface on which the radially inner rolling bellows can unroll and/or lie. The radially inner rolling bellows can thus transfer the fluid pressure radially inwards to the inner wall and therefore does not have to withstand the fluid pressure itself. Thus, the radially inner rolling bellows can also transfer very high pressures.

It is conceivable that the radially inner rolling bellows is configured and/or arranged to withstand a pressure in the liquid volume in the range of at least 0.8 MPa to 4 MPa and/or to transfer such a pressure to the inner wall. This design shows the advantageous interaction of the corresponding positioning of the radially inner rolling bellows and the inner wall. It is conceivable that the radially inner rolling bellows is configured and/or arranged to withstand a pressure peak in the liquid volume in the range of at least 4 MPa to 10 MPa and/or to transfer such a pressure peak to the inner wall. It is conceivable that such a radially inner rolling bellows has reinforcement, for example by means of layers of woven fabric. Although these layers of woven fabric lead to increased stiffness, which is disadvantageous in the context of air springs and undesirable with respect to spring comfort, they are suitable in the present context of a seat-point adjustment for the realization of pressure resistance. This design, too, shows the advantageous interaction of the corresponding positioning of the radially inner rolling bellows and the inner wall.

In particular, a folding bellows would be disadvantageous in this arrangement with regard to radially acting forces. In the prior art, a folding bellows must be able to independently absorb the pressures prevailing in the system. The folds of the folding bellows must remain dimensionally stable so that the folds can fulfil their function. Otherwise, specified folding and unfolding would no longer be possible. In this respect, the radially inner rolling bellows does not have to have such dimensional stability.

According to a conceivable development of the seat-point adjustment device, the radially inner rolling bellows can form at least one rolling fold. The at least one rolling fold can run radially inwards with respect to a fastening point of the radially inner rolling bellows, preferably the closer fastening point, on the associated part. The rolling fold itself can then transfer the axially acting liquid pressure, in the direction towards the central longitudinal axis, to the associated part, whereby the rolling fold itself can have a supporting function. Such axial support is technically not possible with, for example, a sliding seal, an o-ring or even a folding bellows. Such a rolling fold which can be formed by the radially inner rolling bellows advantageously simultaneously provides for the sealing tightness and the movability of the parts relative to one another.

According to a development of the seat-point adjustment device, the inner wall can be formed by one of the two parts. This allows the radially acting liquid pressure to be transferred to the corresponding part, eliminating the need for additional components. This means that the seat-point adjustment device can be pre-assembled in itself before the spring unit is assembled. In addition, radial installation space can be saved as a result. The part that forms the inner wall can thus form a linear guide for the other part. This eliminates the need for additional linear guides, which saves installation space and reduces design complexity.

Alternatively or additionally, the inner wall can be formed by a damper tube of a damper. The damper can be comprised by the seat-point adjustment device. In this case, the seat-point adjustment device can be a seat-point adjustment device assembly. This saves radial installation space. The damper tube can extend along the central longitudinal axis into or through the parts of the seat-point adjustment device. It is conceivable that one of the two parts is fixedly connected to the damper tube and the other of the two parts is movably mounted on the damper tube. The fixed connection can be a force-locking and/or form-locking connection. The damper tube can thus form a linear guide for the corresponding part. This eliminates the need for additional linear guides, which saves installation space and reduces design complexity.

According to a development of the seat-point adjustment device, the seat-point adjustment device can comprise at least one axial guide ring, which movably guides and/or supports one of the two parts relative to the other of the two parts. This ensures reliable support of the corresponding part. The axial guide ring can be arranged between the two parts or between the movably guided part and the damper tube.

According to a conceivable development of the seat-point adjustment device, the axial guide ring can be seal-free. It therefore does not comprise a seal element and is permeable to fluids, in particular gases. Because the liquid volume is sealed by the radially inner seal formed by the radially inner rolling bellows, the invention eliminates the need for further radially inner seals. Thus, the axial guide ring can also be free of seals. This has the advantage that fluid exchange and pressure equalization between regions axially on either side of the axial guide ring is enabled and the axial guide ring also has significantly less wear because it does not have to be tightly fastened. The axial guide ring is therefore not subject to wear. The lower friction also results in improved response and reduced forces during adjustment of the seat-point adjustment device and in improved decoupling of the part connected to the axial guide ring.

According to a development of the seat-point adjustment device, at least one of the two parts can form a bellows guide which guides the radially inner rolling bellows, preferably axially, more preferably axially and radially. The corresponding bellows guide can be a rolling-fold guide, preferably rounded. As a result, the radially inner rolling bellows can be reliably guided in a proximity position, in which the two parts are close to one another, and the effective liquid pressure can be transferred, without damage, to the parts.

According to a development of the seat-point adjustment device, the radially inner rolling bellows can form only one rolling fold or a first rolling fold and a second rolling fold. In the case of only one rolling fold, the fastening of the radially inner rolling bellows is simplified, as there is more radial space for a fastening tool than in the case of two rolling folds. In the case of two rolling folds, which can be axially opposite one another, the maximum possible distance between the two parts (distance position) can be greater, with the same overall height, than in the case of only one rolling fold. This results in efficiency with respect to installation space.

According to a development of the seat-point adjustment device, the radially inner rolling bellows can be fastened, at least in one of its two axial end regions, to an outer circumferential side of a holding geometry of the corresponding part among the two parts or to an inner circumferential side of a holding geometry of the corresponding part among the two parts. In the first variant, the fastening point is loaded in compression. The corresponding axial end region can therefore be loaded radially outwards. In the second variant, the fastening point is loaded in tension. The corresponding axial end region can therefore be loaded radially inwards. The holding geometry can be a ring flange protruding along the central longitudinal axis.

According to a conceivable development of the seat-point adjustment device, the radially inner rolling bellows can axially extend around the corresponding holding geometry from radially outside to radially inside. The radially inner rolling bellows can therefore lie or be arranged on the outer circumference, the free edge and the inner circumference of the corresponding holding geometry. This leads advantageously to a reduction in mechanical load and forms self-locking.

According to a development of the seat-point adjustment device, the radially inner rolling bellows can be fastened to the two parts by means of self-locking rings or by means of force-form-locking rings.

According to a development of the seat-point adjustment device, at least one of the two parts can be of a multi-piece design, and the two rolling bellows can be fastened to different pieces of the multi-piece part. This simplifies pre-assembly or assembly of the parts. In addition, this results in cost advantages in production, because the injection moulds can be less complex, in particular without or with less complex slides.

According to a conceivable development of the seat-point adjustment device, a seal element, preferably a sealing ring, can be arranged between two adjacent pieces of the corresponding multi-piece part. The seal element can seal the liquid volume axially in the corresponding first or second axial direction. As a result, a part can be given a multi-piece design while also being made reliably and permanently tight. This seal element can be configured and/or arranged to perform a static sealing function, preferably exclusively. As a result, the seal element is not exposed to tribological wear and is accordingly durable.

According to a development of the seat-point adjustment device, one of the two parts can engage in the other of the two parts and thereby be guided along the central longitudinal axis. The guiding part can thus form a linear guide for the corresponding guided part. This eliminates the need for additional linear guides, which saves installation space and reduces design complexity. This allows the parts to be moved with guidance relative to one another and independently of surrounding components.

Also conceivable is a spring unit comprising a seat-point adjustment device according to the disclosure and a spring. The spring unit can optionally also comprise the damper tube. The spring can be a coil spring. If the seat-point adjustment device is then arranged in series with the spring, it can be used for static level control. The features already described above with regard to the seat-point adjustment device apply equally to the spring unit disclosed. The advantages already described above with regard to the seat-point adjustment device also arise analogously for the spring unit, to which reference is hereby made.

### BRIEF DESCRIPTION OF THE DRAWINGS

Further features, details and advantages of the invention will be apparent from the wording of the claims and also from the description below of exemplary embodiments with reference to the drawings, in which:

FIG. 1 shows a longitudinal sectional view of a seat-point adjustment device of a first embodiment,

FIG. 2 shows a longitudinal sectional view of a seat-point adjustment device of a second embodiment,

FIG. 3 shows a longitudinal sectional view of a seat-point adjustment device of a third embodiment,

FIG. 4 shows a longitudinal sectional view of a seat-point adjustment device of a fourth embodiment, and

FIG. 5 shows a longitudinal sectional view of a seat-point adjustment device of a fifth embodiment.

### DETAILED DESCRIPTION

In the figures, identical or mutually corresponding elements are each labelled with the same reference signs and therefore are not described again if not appropriate. In order to avoid repetition, features that have already been described will not be described again, and such features are applicable to all elements with the same or mutually corresponding reference signs unless this is explicitly ruled out. The disclosures in the description as a whole are applicable analogously to identical parts with the same reference signs or the same component designations. It is also the case that the statements of position chosen in the description, for example at the top, at the bottom, at the side, etc., relate to the figure illustrated and presently being described and, in the case of a change in position, should be applied analogously to the new position.

Furthermore, it is also possible for individual features or combinations of features from the different exemplary embodiments shown and described to constitute independent inventive solutions or solutions according to the invention.

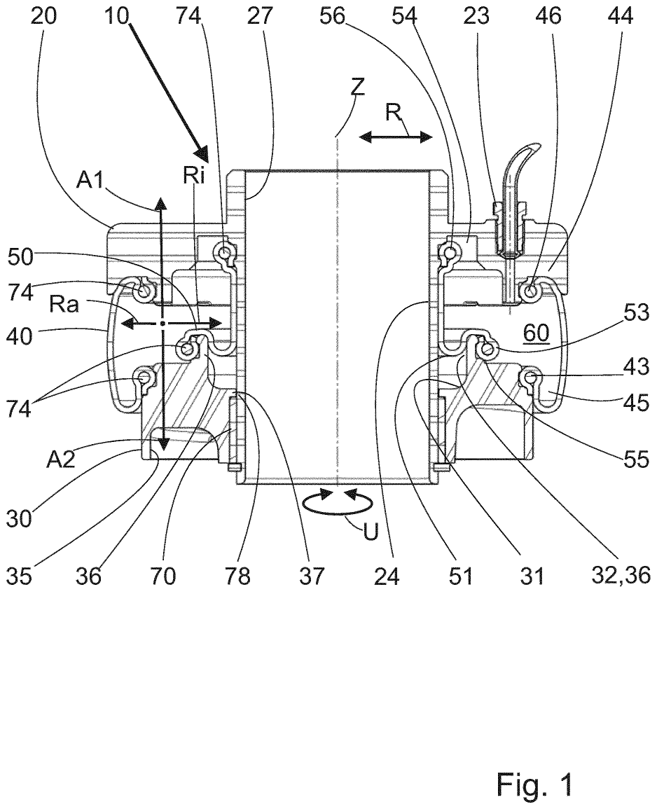

FIG. 1 shows a seat-point adjustment device 10 which is suitable for use in a spring unit. A central longitudinal axis Z extends through the seat-point adjustment device 10. A circumferential direction U extends around the central longitudinal axis Z. A radial direction R extends perpendicularly thereto.

The seat-point adjustment device 10 comprises a first part 20 having a passage 27, which first part is presented as a volume cover and can be connected to a vehicle. The seat-point adjustment device 10 comprises a second part 30 having a passage 37, which second part is likewise presented as a volume cover and has a spring receptacle 35 suitable for receiving a spring of a spring unit, for example a coil spring.

The two parts 20, 30 are movable relative to one another along the central longitudinal axis Z, and they can be moved between a proximity position and a distance position.

The first part 20 forms an inner wall 24. The inner wall 24 can be a cylindrical portion extending along the central longitudinal axis Z. The inner wall 24 of the first part 20 provides a guide 78, in the form of a linear guide, for the second part 30. The inner wall 24 of the first part 20 also engages in the second part 30 along the central longitudinal axis Z. A seal-free axial guide ring 70 guides one of the parts 20, 30 with respect to the other. The axial guide ring 70 is arranged on the inner wall 24 and is permeable to fluids due to the absence of a seal.

The seat-point adjustment device 10 also comprises a radially outer rolling bellows 40, which is fastened, at one axial end, to the first part 20 and, at the other axial end, to the second part 30. For this purpose the axial end regions 43, 44 form fastening points 45, 46, and the radially outer rolling bellows 40 is fastened by means of force-form-locking rings 74. The seat-point adjustment device 10 also comprises a radially inner rolling bellows 50, which is likewise fastened, at one axial end, to the first part 20 and, at the other axial end, to the second part 30.

The axial end regions 53, 54 of the radially inner rolling bellows 50 form fastening points 55, 56 for this purpose, and the radially inner rolling bellows 50 is fastened by means of force-form-locking rings 74. The end region 54 of the radially inner rolling bellows 50 is fastened to the inner wall 24. The two bellows 40, 50 span between the parts 20, 30.

The seat-point adjustment device 10 also comprises a toroidal liquid volume 60. The liquid volume 60 is delimited in a first axial direction Al by the first part 20, in a second axial direction A2 by the second part 30, in a radially outward direction Ra by the radially outer rolling bellows 40, and in a radially inward direction Ri by the radially inner rolling bellows 50. The axial directions A1 and A2 extend opposite to each other. The radial directions Ra, Ri extend opposite to each other. The liquid volume 60 is sealed radially inward exclusively by the radially inner rolling bellows 50.

The radially inner rolling bellows 50 is configured and arranged to unroll on and lie on the outer circumferential surface of the inner wall 24. The radially inner rolling bellows 50 also forms a rolling fold 51 which faces the second part 30. Proceeding from the closer fastening point 55 of the radially inner rolling bellows 50, the rolling fold 51 runs radially inwards. The second part 30 forms a bellows guide 31, which is a rolling-fold guide for the rolling fold 51. The rolling fold 51 is thereby guided axially and radially.

The second part 30 forms a holding geometry 32 for the radially inner rolling bellows 50, the holding geometry 32 being designed as a ring flange 36 which protrudes along the central longitudinal axis Z. The end region 53 of the radially inner rolling bellows 50 is fastened to the outer circumferential side of the holding geometry 32, so that the holding geometry 32 is subjected to a compressive load. It is also evident that the radially inner rolling bellows 50 extends around the holding geometry 32 from radially outside to radially inside, proceeding from the fastening point 55.

It is evident that the two parts 20, 30 are arranged opposite one another along the central longitudinal axis Z and with respect to the liquid volume 60. The distance between the two parts 20, 30 can be set by means of the filling state of the liquid volume 60, with a volume increase of the liquid volume 60 causing a distance increase, while a volume decrease of the liquid volume 60 causes a distance decrease. For this purpose, the first part 20 comprises a valve 23 for introducing a liquid into or releasing it from the liquid volume 60.

The seat-point adjustment device can in principle form the spring seat on the body side or the spring seat on the hub carrier side.

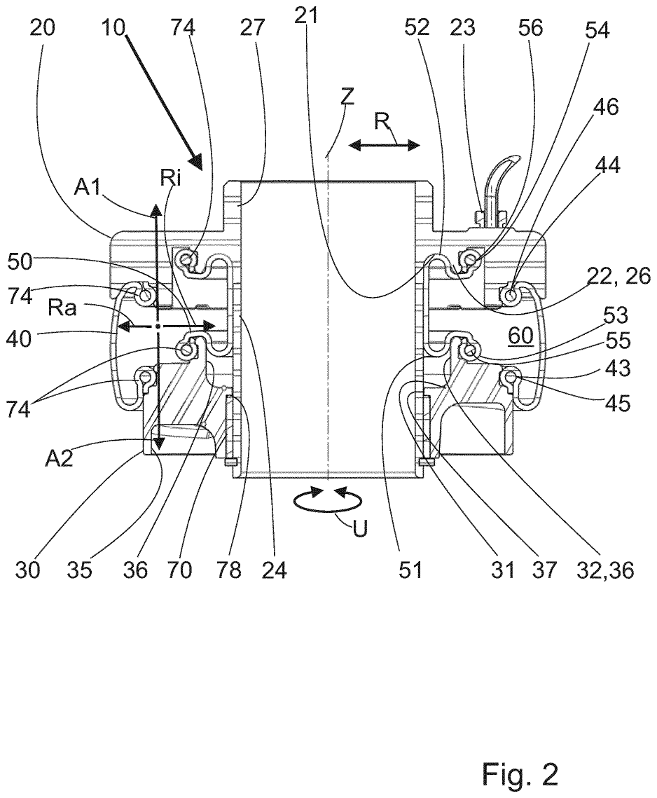

FIG. 2 shows a seat-point adjustment device 10 according to a further refinement. To avoid repetitions, only the differences of FIG. 2 from FIG. 1 are described below. Features not described are to be regarded as disclosed and described.

The radially inner rolling bellows 50 forms a further rolling fold 52, which faces the first part 20. Proceeding from the closer fastening point 56 of the radially inner rolling bellows 50, the rolling fold 52 runs radially inwards. The first part 20 forms a bellows guide 21, which is a rolling-fold guide for the rolling fold 52. The rolling fold 52 is thereby likewise guided axially and radially.

The first part 20 forms a holding geometry 22 for the radially inner rolling bellows 50, the holding geometry 22 being designed as a ring flange 26 which protrudes along the central longitudinal axis Z. The end region 54 of the radially inner rolling bellows 50 is fastened to the outer circumferential side of the holding geometry 22, so that the holding geometry is subjected to a compressive load. It is evident that the radially inner rolling bellows 50 extends around the holding geometry 22 from radially outside to radially inside, proceeding from the fastening point 56.

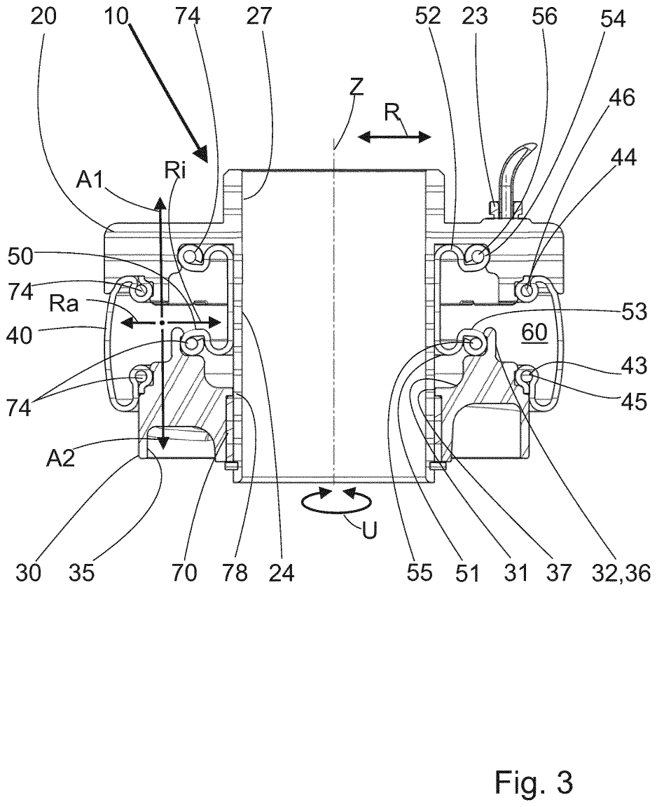

FIG. 3 shows a seat-point adjustment device 10 according to a further refinement. To avoid repetitions, only the differences of FIG. 3 from FIG. 1 are described below. Features not described are to be regarded as disclosed and described.

The end region 53 of the radially inner rolling bellows 50 is now fastened to the inner circumferential side of the holding geometry 32, so that the holding geometry 32 is subjected to a tensile load. It is also evident that the radially inner rolling bellows 50 no longer extends around the holding geometry 32 from radially outside to radially inside. The end region 54 of the radially inner rolling bellows 50 is now arranged not on the inner wall 24 but on a portion of the first part 20 opposite in the radial direction R.

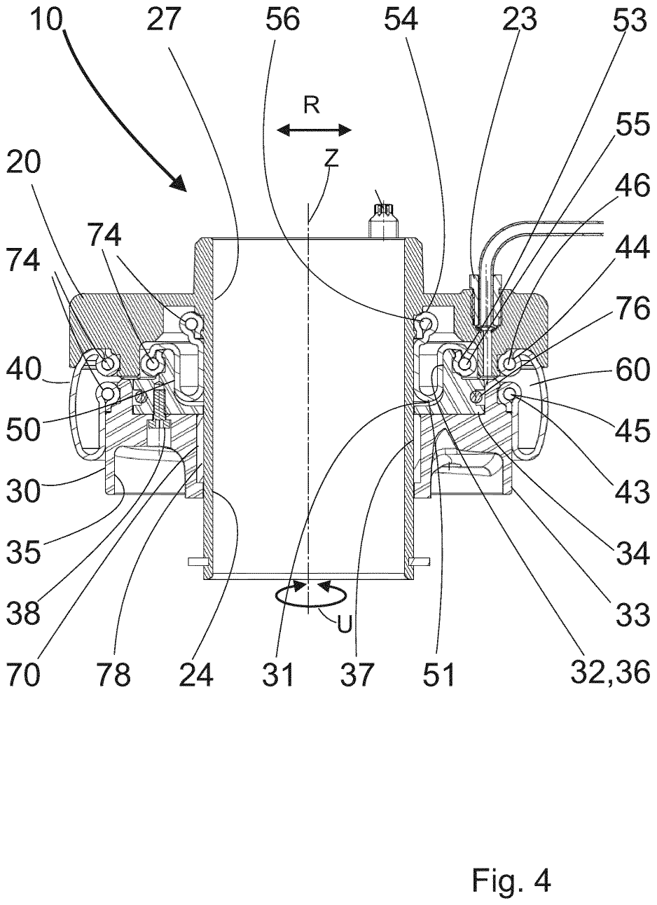

FIG. 4 shows a seat-point adjustment device 10 according to a further refinement. To avoid repetitions, only the differences of FIG. 4 from FIG. 1 are described below. Features not described are to be regarded as disclosed and described.

The second part 30 is of a multi-piece design and comprises a first piece 33 and a second piece 34. The first piece 33 is arranged radially outside with respect to the second piece 34. Between the two pieces 33, 34, a sealing ring 76 is provided for sealing the liquid volume 60 in the second axial direction A2.

The fastening point 45 of the radially outer rolling bellows 40 is formed on the first piece 33, while the fastening point 55 of the radially inner rolling bellows 50 is formed on the second piece 34. This greatly facilitates the installation of both rolling bellows 40 and 50. The first piece 33 and the second piece 34 are connected to one another by means of a fastening element 38, here a screw by way of example.

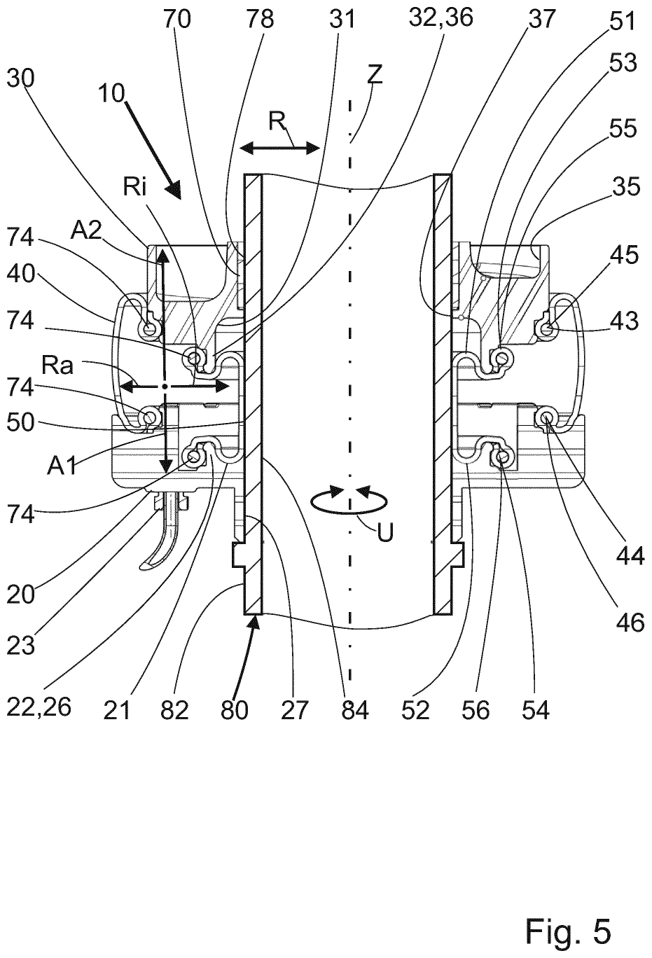

FIG. 5 shows a seat-point adjustment device 10 according to a further refinement. To avoid repetitions, only the differences of FIG. 5 from FIG. 1 are described below. Features not described are to be regarded as disclosed and described.

The seat-point adjustment device 10 or seat-point adjustment device assembly now comprises a damper 80 with damper tube 82. The damper tube 82 extends through the two parts 20, 30 along the central longitudinal axis Z. The first part 20 is fixedly connected to the damper tube 82, while the second part 30 is movable relative to the damper tube. The axial guide ring 70 is now arranged on the damper tube 82. The damper tube 82 thus forms a linear guide for the second part 30.

An inner wall is now formed not by one of the two parts 20, 30. The inner wall 84 is now formed by the damper tube 82.

The radially inner rolling bellows 50 forms a further rolling fold 52, which faces the first part 20. Proceeding from the closer fastening point 56 of the radially inner rolling bellows 50, the rolling fold 52 runs radially inwards. The first part 20 forms a bellows guide 21, which is a rolling-fold guide for the rolling fold 52. The rolling fold 52 is thereby likewise guided axially and radially.

The first part 20 forms a holding geometry 22 for the radially inner rolling bellows 50, the holding geometry 22 being designed as a ring flange 26 which protrudes along the central longitudinal axis Z. The end region 54 of the radially inner rolling bellows 50 is fastened to the outer circumferential side of the holding geometry 22, so that the holding geometry is subjected to a compressive load. It is evident that the radially inner rolling bellows 50 extends over the holding geometry 22 from radially outside to radially inside, proceeding from the fastening point 56.

The invention is not restricted to any of the embodiments described above and instead can be modified in various ways. All the features and advantages that are apparent from the claims, the description and the drawing, including structural details, spatial arrangements and method steps, may be essential to the invention both individually and in a very wide variety of combinations.

The scope of the invention encompasses all combinations of at least two of the features disclosed in the description, the claims and/or the figures.

To avoid repetitions, features disclosed in relation to a device are also considered to be disclosed, and claimable, in relation to a method. It is likewise the case that features disclosed in relation to a method are considered to be disclosed, and claimable, in relation to a device.

1. A seat-point adjustment device through which a central longitudinal axis extends, comprising:
a first part and a second part, each having a passage in a direction of the central longitudinal axis;
a radially outer rolling bellows which extends, radially outside with respect to a liquid volume, from the first part to the second part; and
a radially inner rolling bellows which extends, radially inside with respect to the liquid volume, from the first part to the second part,
wherein the radially inner rolling bellows forms a radially inner seal of the liquid volume.

2. The seat-point adjustment device according to claim 1, comprising an inner wall which is arranged radially inside with respect to the radially inner rolling bellows, the radially inner rolling bellows being configured and/or arranged to unroll on and/or lie on the inner wall.

3. The seat-point adjustment device according to claim 2, wherein the inner wall is formed by one of the two parts and/or the inner wall is formed by a damper tube of a damper.

4. The seat-point adjustment device according to claim 1, wherein at least one axial guide ring, which movably guides and/or supports one of the two parts relative to the other of the two parts.

5. The seat-point adjustment device according to claim 1, wherein at least one of the two parts forms a bellows guide which guides the radially inner rolling bellows axially.

6. The seat-point adjustment device according to claim 1, wherein the radially inner rolling bellows forms only one rolling fold or a first rolling fold and a second rolling fold.

7. The seat-point adjustment device according to claim 1, wherein the radially inner rolling bellows is fastened, at least in one of its two axial end regions to an outer circumferential side of a holding geometry of the corresponding part among the two parts or to an inner circumferential side of a holding geometry of the corresponding part among the two parts.

8. The seat-point adjustment device (10) according to claim 1, wherein the radially inner rolling bellows is fastened to the two parts by means of self-locking rings or by means of force-form-locking rings.

9. The seat-point adjustment device according to claim 1, wherein at least one of the two parts is of a multi-piece design, the outer and inner rolling bellows being fastened to different pieces of the multi-piece part.

10. The seat-point adjustment device according to claim 1, wherein one of the two parts engages in the other of the two parts and is thereby guided along the central longitudinal axis.
